(19) United States
(12) Patent Application Publication
(10) Pub. No.: US 2007/0130105 A1
(43) Pub. Date: Jun. 7, 2007

(54) Obtaining server usage information

(75) Inventor: Ram P. Papatla, Sammamish, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 11/262,125

(22) Filed: Oct. 28, 2005

(51) Int. Cl. G06F 17/30; G06F 7/00

(52) U.S. Cl. 707/2

(57) ABSTRACT

Methods of obtaining server usage information and organization information related to the market/organizational context in which the server is operated. Server information is collected from servers and is sent over a network. Server usage information may be obtained by receiving server information over a network and processing the server information. Server usage information may be segmented based on market segments of the organizations that operate the servers. Reports may be generated and provided to the customer. Server usage information may be used to improve server-related products and services.

### BACKGROUND OF INVENTION

1. Field of Invention

The invention relates generally to obtaining server usage information, and more specifically to obtaining server usage information and associated organization information using a network.

2. Discussion of Related Art

Many organizations operate one or more servers that perform various computing tasks. Servers typically communicate with multiple client computers over a network. For example, some servers communicate with client computers within an organization over a local network, and some servers communicate with client computers over the Internet. Many different types of servers are available which perform a variety of different tasks and can be configured in a variety of different ways.

For example, different servers may have different of types of hardware, such as types of processors, number of processors, processor speeds and memory. Different servers may use different software configurations, such as types of operating systems and applications.

Servers can perform a variety of server roles. For example, a server may function as a file server, a print server, a mail server, an Internet server or a virtual private network (VPN) server. Some servers are dedicated to performing a single role, and some servers perform more than one role.

Services are available for determining information about how organizations deploy their servers. For example, services such as Server Tracker and Pulse rely on human representatives to gather information about servers by conducting phone surveys of network administrators. Network administrators may answer questions about the roles performed by their servers and configuration of their servers. In some cases, network administrators may be randomly chosen to participate a phone survey. Statistics and other results are compiled based on the survey information that is obtained.

The amount of information collected using phone surveys is limited by human time constraints. For example, the number of questions that can be asked during a phone call may be limited because the network administrator does not have time to answer a lot of questions. As another example, the number of network administrators that can be surveyed is limited to the number of people that the human representatives have time to survey.

### SUMMARY OF INVENTION

In one aspect of the invention, server information may be obtained by communicating with servers over a network. Server information for each server may be associated with information about the organization that operates the server. Server information and organization-related information may be obtained for multiple organizations and multiple servers. Based on the information that is obtained, an objective assessment may be made of how organizations use their servers. Assessments of server usage may be determined for particular market segments. Obtaining an objective assessment of server usage may facilitate providing server products and services, and may ultimately increase customer satisfaction.

In another aspect, the invention relates to a method, implemented on a computer, of obtaining server usage information. The method includes receiving first organization information related to a first organization that operates a first server. The method also includes receiving, over a network, first server information related to the first server. The method also includes receiving second organization information related to a second organization that operates a second server. The method also includes receiving, over a network, second server information related to the second server. The method further includes determining server usage information based on the first and second organization information and the first and second server information.

In yet another aspect, the invention relates to a method, implemented on a computer, of providing server usage information. The method includes receiving organization information related to a organization that operates a server. The method also includes receiving, over a network, server information related to the server. The method also includes determining server usage information based on the server information. The method further includes providing the server usage information to the organization that operates the server.

In yet another aspect, the invention relates to a computer-readable medium having computer-executable instructions implemented by a processor for performing steps. The steps include receiving first organization information related to a first organization that operates a first server. The steps also includes receiving, over a network, first server information related to the first server. The steps also include receiving second organization information related to a second organization that operates a second server. The steps also include receiving, over a network, second server information related to the second server. The steps further includes determining server usage information based on the first and second organization information and the first and second server information.

In a further aspect, the invention relates to a method, implemented on a computer, of obtaining server usage information. The method includes receiving, over a network, by a first site, organization information related to an organization that operates a server. The method also includes receiving, over a network, by a second site, server information related to the server. The method further includes determining server usage information based on the organization information and the server information.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flow chart illustrating an example of a method of obtaining server information;

FIG. 2 illustrates an example of a information collection tool that may be used to collect the server information;

FIG. 3 is a block diagram illustrating an example of the method of obtaining server usage information; and

FIG. 4 is a block diagram illustrating a server information processing system.

### DETAILED DESCRIPTION

In one aspect of the invention, server information may be obtained by communicating with servers over a network. An organization may choose to participate in a server information-collection program, discussed in further detail below. To collect the server information, a tool may be installed on an organization's servers or on another device associated with the organization. Once the server information is collected, the tool may send the server information to a trusted site over a network. Once received by the trusted site, server information may be associated with information about the organization that operates the server (e.g., the size of the organization, number of servers operated, and number of client computers operated). Obtaining server information over a network may supplement or replace prior methods of gathering this information, and may enable obtaining an objective assessment of server usage.

Once the server information is received, it may be used in a variety of ways.

As one example, obtaining server information over a network may enable obtaining an unbiased assessment of how organizations use their servers in specific market contexts. Server usage information may be determined based on server information received from multiple different organizations and servers. Once received, information about each server may be linked with information about the organization that operates the server (e.g., the size of the organization).

Obtaining accurate server usage information may enable server hardware and/or software developers and manufacturers to provide products and services in response to market demands. Based on the server usage information, reports may be generated and provided to development teams. Development teams may use these reports to improve server hardware and/or software products and services.

A development team that is responsible for a particular product line a (e.g., Windows Server™) may wish to obtain specific kinds of information about how organizations use their servers, so that the product can be improved. The type of information that is collected about the server may be adjusted based on these types of queries, and server usage reports may be generated that take into account this new information. In some cases, a development team may use the server information obtained to identify customers to call for follow-up questions.

Server usage information may be provided to a marketing team which may use the information to effectively market server-related products and services.

Received server information may be used to generate reports for particular customers about their servers. As one example, a customer participating in the program may wish to obtain information about how its servers are performing. Using the server information received from the customer, a server usage report may be generated and provided to the customer.

Currently, software packages are available which allow organizations to monitor their server performance. However, these software packages may be prohibitively expensive, especially for relatively small organizations. Therefore, this aspect of the invention may be particularly valuable to relatively small organizations, and may be provided to the customer as a benefit of participating in the server information-collection program.

As a further example, obtaining server-related information over a network may facilitate providing customer assistance. For example, a customer may wish to obtain help or information related their servers. The customer may contact a trusted organization associated with the trusted site to obtain assistance. A representative associated with the trusted organization may provide help to the customer based on server usage information determined based on information received from the customer's servers. For example, the representative may generate a server usage report and provide verbal guidance to the customer.

Aspects of the invention that relate to obtaining server information and organization information will now be described. Examples of server information and organization are provided below. However, the invention is not limited to any particular types of server information and organization information described herein. Furthermore, the invention is not limited to any particular method or system for obtaining this information.

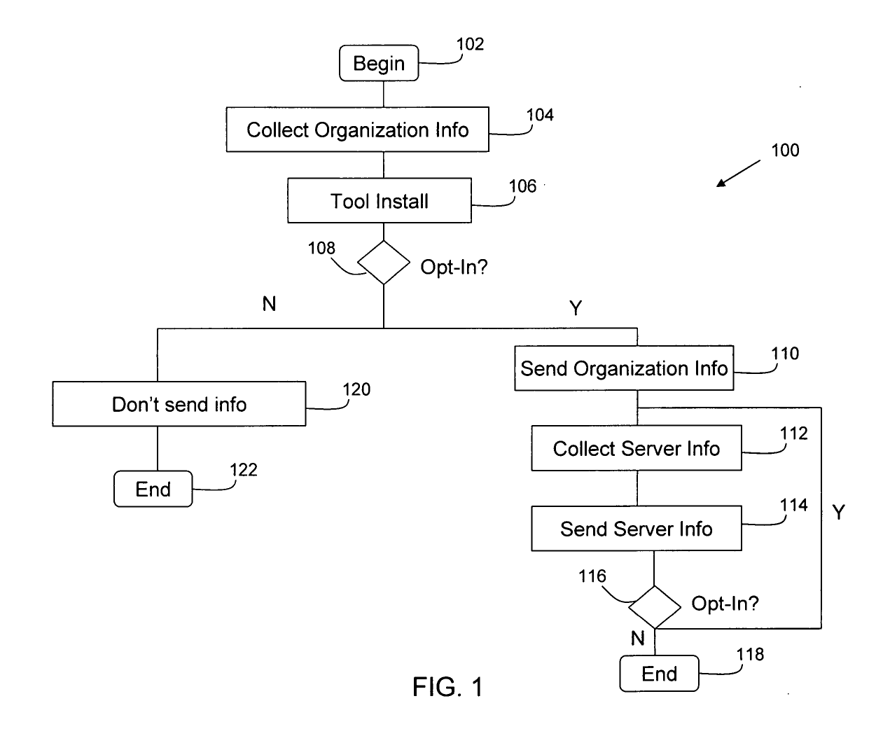

FIG. 1 is a flow chart illustrating an example of a method 100 of obtaining server information. In block 102, method 100 begins.

In block 104, organization information may be collected. Organization information may be collected in any suitable way. For example, if an organization wishes to participate in the server information-collection program, it may be required to provide organization information. In one embodiment of the invention, organization information may be required before downloading the tool which collects the server information. For example, a representative of the organization may be required to enter information at a networked device (e.g., a server), and the information may be sent over the Internet to a trusted site.

Any suitable type of organization information may be collected. For example, organization information may include the number of employees employed at the organization, the number of servers operated by the organization and/or the number of client computers operated by the organization. Organization information may include contact information for a network administrator associated with the organization.

It is not necessary that the organization information be sent over a computer network. The organization information may be sent in any suitable way, e.g., by mail or telephone.

Once the organization information has been received by the trusted site, an information collection tool 200 may be installed at block 106. Information collection tool 200 may be a software module configured to collect various types of information, as will be described in further detail below.

Information collection tool 200 may be installed on a server about which information is desired to be collected. However, information collection tool 200 need not necessarily be installed on the same server about which information is collected. As one example, the tool may be installed on a work station that is communicatively coupled to one or more servers via a network connection. Using the tool, a participant may select one or more servers. The tool may then receive data related to the selected servers.

Information collection tool 200 may be obtained in any suitable way. For example, the tool may be obtained by downloading it from the trusted site onto each server for which information is to be collected. As another example, the tool may be “pushed” onto a plurality of servers by a network administrator associated with the organization.

During the tool installation, or at any other suitable time, a determination may be made as to whether the organization installing the tool wishes to participate in the program (i.e., the organization chooses to opt-in). This determination may be made in block 108.

During installation of the tool, the participant may be required to view and agree to one or more agreements that govern use of the tool. For example, such agreements may include software license agreements, privacy agreements, non-disclosure agreements and/or other agreements. Such agreements may cover the version of the tool that is currently installed and any subsequent updates or changes to the tool. To participate in the program and/or finish installation of the tool, the participant may be required to agree to the terms of the agreements, for example, by clicking on a button indicating acceptance of the agreement. If the participant fails to accept the agreement, the organization information collected in block 104 may not be sent to the trusted organization. In this case, installation of the tool and collection of information may be aborted in block 120. The method 100 may then end at block 122.

If the agreements are accepted, the organization information collected in block 104 may be sent to the trusted organization in block 110. For example, the organization information may be sent to the trusted organization over a network connection. Once the trusted organization receives the customer information it may associate the organization information with a unique identifier. The server information that is obtained (i.e., from servers operated by the organization) may be associated with this same unique identifier. Associating organization information and server information with a unique identifier may enable obtaining customer-specific server usage data and generating customer-specific reports.

Server information may be collected in block 112. For example, server information may be collected using information collection tool 200. Information gathering is described in greater detail in co-pending U.S. application Ser. No. ______ filed on ______ entitled “______” and co-pending U.S. application Ser. No. ______ filed on ______ entitled “______”.

The server information that is collected may include multiple different types of server information.

For example, server information may include the number and/or types of roles performed by the server. For example, the server may be a web server, an e-mail server or any other suitable type of server. Various types of information related to the roles that a server plays may be collected, such as the type of role, the number of roles or any other suitable information.

Server information may also include information about the various technologies employed by the server. As one example, it may be determined whether the server is using a 64 bit CPU. As another example, it may be determined whether the server is using a virtual machine.

Server information may also include information about the software used by the server. For example, information may be collected about the number and types of applications run by the server or which filters or drivers are installed. Any suitable type of software information may be collected.

Server information may also include hardware information about the server. For example, server information may include the CPU speed, the amount of RAM, the amount of local storage, or any other suitable hardware information may be collected.

In addition to the types of server information discussed above, any other suitable type of server information may be collected, such as the number of users connected to the server, for example.

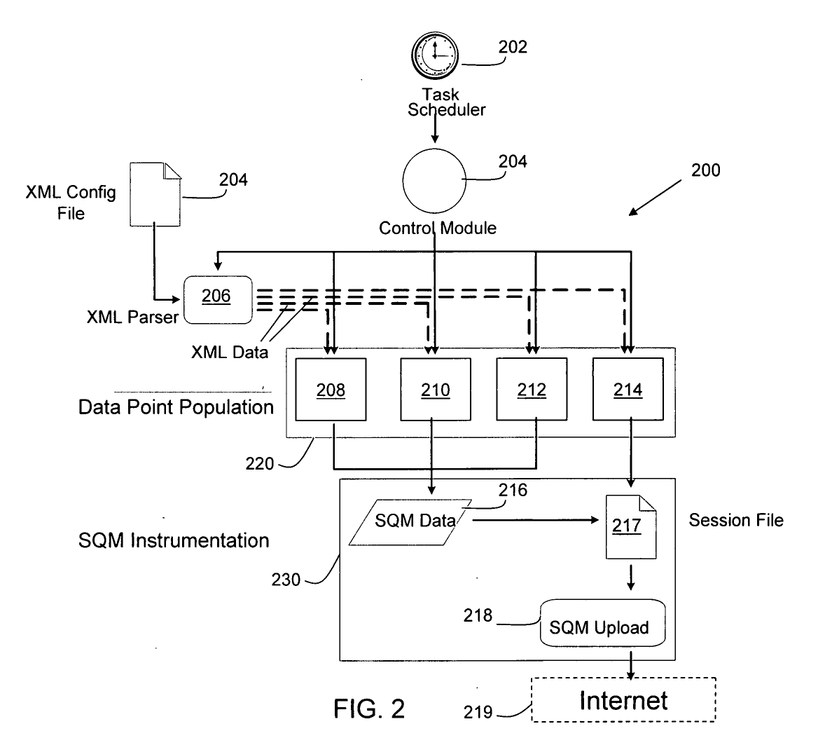

FIG. 2 illustrates an example of a information collection tool 200 that may be used to collect the server information. Information collection tool 200 may be a software module programmed in any suitable programming language.

Information collection tool 200 may include a task scheduler 202 that may schedule the times at which server information is to be collected. Task scheduler 202 may schedule the times at which server information is to be sent over a network. For example, task scheduler 202 may include a user interface that a user may use to set the times at which the server information may be collected and/or sent over a network. For example, using the task scheduler, a user may set the tool to collect information at regular intervals, for example, every evening at midnight.

The information collection tool 200 may include a control module 204 which may receive instructions from the task scheduler 202. Control module 204 may control various aspects of the information collection and the sending of the information. For example, in response to receiving an instruction from task scheduler 202, control module 204 may begin collecting server information at a particular time.

Information collection tool 200 may receive a configuration file 204 which may contain instructions as to which information is to be collected. The configuration file 204 may be, for example, an XML configuration file. Once information collection tool 200 receives the XML configuration file 204, it may be parsed by XML parser 206 to extract instructions for various different components of tool 200. Once this information is extracted, it may be sent to data point population module 220 and include the type of information to be extracted by data point population module 220.

Data point population module 220 may include a WMI interpreter 208, a registry reader 210, an error log scanner 212 and an initialization information module 214. Each of these modules may be operative to collect server information that may include multiple data points. WMI interpreter 208 may be configured to obtain information related to Windows Management Interface. Registry reader module 210 may be configured to obtain registry information for the server. Error log scanner module 212 may be configured to obtain error log and/or event log information from an error log stored on the server. Initialization information module 214 may be configured to determine information related to initialization parameters of the server.

Once the server information is obtained by data point population module 220, it may be sent to SQM instrumentation module 230. Once SQM instrumentation module 230 receives the server information, it may translate the server information into SQM information 216. SQM information 216 may be the server information translated into SQM format. SQM information 216 may be stored in a session file 217. SQM upload module 218 may then upload the session file 217 to a remote location over the Internet 219. For example, the session file 217 may be sent to the trusted site as discussed above.

One or more measures may be taken to protect the security of the server information as it is sent over a network. For example, the server information may be encrypted by encrypting the session file 217.

As another example, the server information that is sent may include answers to queries about the server (e.g., from the configuration file), but the server information that is sent may not be sent with the queries themselves. Therefore, if the server information is intercepted by a third party, the third party may not be able to determine information about the server. For example, the third party may intercept the number 512, but may not be able to determine the meaning of the number. In this case, 512 may be the number of megabytes of RAM used by the server, but this context may not be easily obtained by a third party that intercepts the information.

As a further example, the server information may be sent with a unique identifier that identifies the server to the trusted entity. To protect privacy, this unique identifier may be a randomly-generated number (e.g., a 128 bit integer, such as a GUID) created when the organization decides to “opt-in” for a particular server. Even if this unique identifier is intercepted during the sending of server data, the third party that intercepts the data should not be able to associate the unique identifier with the organization. As another security measure, the secure identifier may be hashed using any suitable algorithm.

Information collection tool 200 as illustrated with respect to FIG. 2 is only one example of a tool that may be used for collecting information from servers. The tool may be configured in any suitable way and need not necessarily collect the types of data points described with respect to FIG. 2. Other types of data points may collected. In addition, the implementation of tool 200 is not limited to the ways of representing information, e.g., XML and SQM, as illustrated with respect to FIG. 2. Any other suitable representations of information may be used.

In some situations, the types of information to be collected by tool 200 may be updated by receiving an XML configuration file 204. In some aspects of the invention, XML configuration file 204 may be received over a network (e.g., from the trusted site) at various points in time to update the data points that are collected by information collection tool 200.

Referring again to FIG. 1, once the server information has been collected in block 112, server information may be sent to the trusted organization in block 114. For example, as illustrated in FIG. 2, the server information may be sent to the trusted organization over the Internet or any other suitable network.

Method 100 may include further steps of collecting server information in block 112 and sending the server information in block 114. These steps may be performed repeatedly (e.g., at regular intervals). In some cases, the times that server information may be collected and/or sent may be set by a user.

If the participant no longer wishes to participate in the server information-collection program, the participant may “opt-out” of the program at any time. Opting-out of the program may prevent the tool from collecting further information about the server and sending any further communications. A participant may choose to opt-out for one server or multiple servers. As one example, opt-out may be initiated using tool 200 (e.g., by choosing an option from a pull-down menu).

As another option, if the participant no longer wishes to participate, the participant may uninstall the information collection tool 200. Uninstalling the tool will remove the tool from the participant's device and prevent the tool from collecting further information about the server and sending any further communications.

If the participant decides to opt-out or uninstall tool 200, method 100 ends at block 118.

Method 100 need not necessarily include all the steps illustrated with respect to FIG. 1. For example, a user need not necessarily install information collection tool 200. In some circumstances, information collection tool 200 may come installed with an operating system on the organization's server.

Some acts of method 100 may be implemented on a computer, e.g., a server. However, it is not necessary that all of the steps of method 100 be performed on a computer. As one example, sending of organization information in block 110 need not necessarily be performed by a computer. Rather, customer information may be obtained in another suitable way, e.g., by telephone or mail.

Steps of method 100 need not necessarily be performed in the order illustrated in FIG. 1. For example, some steps may be performed concurrently to other steps.

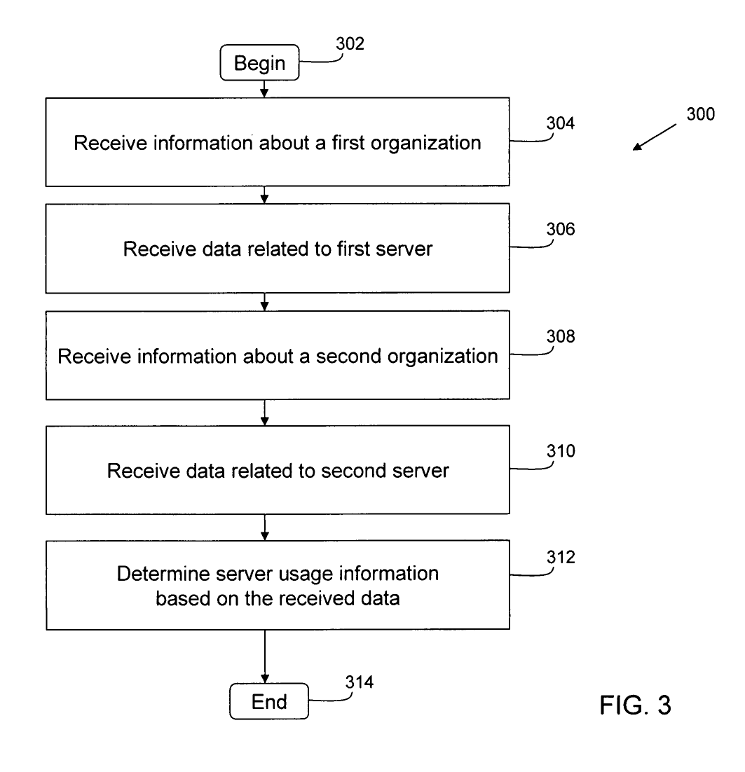

FIG. 3 is a block diagram illustrating an example of the method 300 of obtaining server usage information. In block 302, the method may begin.

In block 304, information about a first organization may be received. The information that is received in block 304 may be received in response to organization information being sent in block 110 of FIG. 1. The organization information may be received in any suitable way, e.g., over a network.

Once the information about the first organization has been received, information related to a server operated by an organization may be obtained in block 306. Information may be received in block 306 by the trusted site in response to server information being sent in block 114 of FIG. 1. For example, the server information may be received at the trusted site in SQM format. As discussed above, the server information may received in encrypted format.

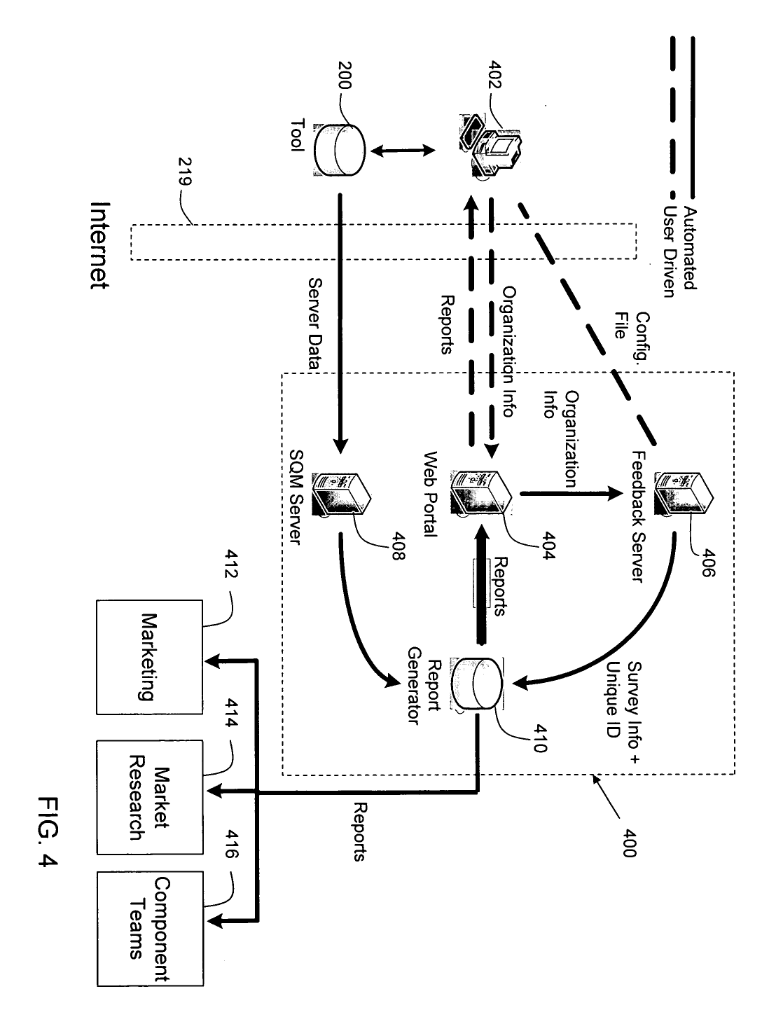

FIG. 4 is a block diagram illustrating a server information processing system 400 that may be associated with one or more trusted sites. Server information processing system 400 may be operative to receive server information from servers or other devices (e.g., server 402) over a network and to process the server information.

Server information processing system 400 may include a web portal 404, a feedback server 406 and an SQM server 408 which communicate with server 402 and tool 200. The processing system may further include a report generator 410.

In block 304 of FIG. 3, organization information may be received by web portal 404. Web portal 404 may send the organization information to feedback server 406. Once feedback server 406 receives the organization information, it may generate a configuration file (e.g., XML configuration file 204) and send the configuration file to server 402 or another device associated with the organization.

Sending a configuration file to server 402 may enable updating the type of information to be collected from servers associated with the organization. Sending a configuration file may enable updating of the information to be collected without recompiling or reshipping new versions of tool 200.

In block 306, server information may be received by SQM server 408. SQM server 408 may process the server information and send the server information to report generator 410.

In block 308, organization information may be received from a second organization that operates a server. Information may be received in block 308 as described above with respect to block 304.

In block 310, information about the second organization's server may be received. The server information may be received in block 310 as described above with respect to block 306.

Information may be received from multiple organizations in addition to the two organizations described above. Server information may be received from multiple servers and/or other devices associated with the organization. Server usage information may be determined based on information received from the multiple organizations and multiple servers.

In block 312, server usage information may be determined based on the information received. Server usage information may be determined by report generator 410, or any other suitable device.

A variety of server usage information may be determined. Server usage information may include aggregated server information for multiple servers. Various operations may be performed on the raw server information received from multiple servers to generate server usage information. For example, algorithms may be applied to server information to determine various aggregated parameters (e.g., mean server speed, percentage of servers running virtual machines, total number of servers using a particular hardware component, etc.). Any suitable techniques may be used to determine additional useful information from the server information that is received.

Organizations' market segments may be determined based on the received organization information. For example, it may be determined whether an organization is a small organization, a medium sized organization or a large organization. Aggregated server usage information may be determined for a market segment by compiling server data for organizations in the same market segment.

Based on the server usage information, server usage reports may be generated. Reports may be delivered to a variety of different teams, such as marketing team 412, market research team 414 and component teams 416. In one aspect of the invention, reports may be provided to customers. The report generator 410 may provide the report to web portal 404.

The customer may communicate with web portal 404 to obtain one or more reports. The reports may be customer-specific, and may include server usage information related to the customer's servers. Alternatively, the reports may represent aggregated server usage information for multiple customers. By obtaining aggregated server usage information, the customer may compare the operation of their servers with that of other organizations in the marketplace. However, a customer may be prevented from viewing specific server information for a different customer.

In block 314, method 300 ends.

Method 300 need not necessarily be performed in the order described above. For example, some steps may be performed concurrently to other steps.

Device 402 need not necessarily be a server, but could be any suitable computing device operative to communicate over a network (e.g., a personal computer). In some circumstances, information may be processed by other devices before and/or after being received and/or sent by device 402. Device 402 may communicate with one or more servers operated by the organization, and may send and receive data collected from the servers.

In one aspect of the invention, organization information and server information may be received by different sites (e.g., web portal 404 and SQM server 408). Receiving these two different types of information by two or more different sites may help protect the privacy and security of the data. Once the organization information and the server information is received by the two sites, these two types of information may be associated in a more secure environment (e.g., a local network).

Various benefits may be provided to encourage participation in the server information-collection program.

As one example, a customer may be provided with the server information, server usage information and/or server reports, as discussed above. The customer may have an account on a web portal 404 (e.g., MS Connect) in order to download the software, and may also be able to use web portal 404 to give feedback and receive feedback. In one aspect of the invention, the customer may have direct communication with component teams 416 via web portal 404. If problems occur with server information-collection tool 200, the customer can use web portal 404 to communicate with a help representative.

In one aspect of the invention, customers may be able to view technical documents related to the information collection, using web portal 404. This may allow the customer to feel comfortable with the server information-collection by providing a substantial amount of information about the program.

In another aspect of the invention, an open dialog with customers may be promoted by various techniques. For example, developers of the information collection program may post a “blog” on the web portal which customers can view and respond to provide feedback.

Several scenarios will now be described.

Scenario 1: A customer may be invited to participate in the server information-collection program, and decides to participate. After all, the tool requires may require no further interaction after being installed. After a month of running the tool, the customer decides to log back in to their web portal site (e.g., MS Connect), and may discover that there are reports waiting for them—reports about which machines crash most frequently, the average fragmentation of the file server, and the number of CHKDSK errors that occur on each machine. These reports may help the customer make decisions about which hardware is the best purchase for him in the next year, as well as how frequently to defragment his file server.

Scenario 2: A new XML configuration file may be posted to the web, and the customer is informed of this on their web portal site (e.g., Microsoft Connect). The customer may be guided through the steps of downloading the new XML file, and place it in the correct location on the server. Later that night at the time specified in the task scheduler, the data points defined in the XML configuration file are gathered. Then, at the time specified as the transmission time in the task scheduler, the server data is sent over the internet. The server data may be send with a unique identifier that identifies the machine and also an identifier that identifies the version of the XML configuration file.

Scenario 3: A member of a development team would like to know first of all what percentage of mid-market users are taking advantage of a particular data backup product. In particular, he would like to know the average amount of data that is being backed up by these mid-market users. After getting the average numbers, the development team can look into the raw data and find the organizations that are not near the average (i.e., the outliers). For example, the development team be looking for people with comparatively large amounts of data being backed up daily. The team can then contact those individual customers in order to determine what kind of hardware they are using for these large capacity backups. Once they realize that all of the large capacity backups is being done using a particular technology, they can optimize their backup code to take greater advantage that particular technology.

Scenario 4: Market research may show that product X is not being used in favor of product Y. A component team for product X may request to add a data point to the XML configuration file that checks the registry for the occurrence of any of product Y's settings (if present, this would indicate that product Y is installed). They also request a data point which will indicate whether product X is installed. They can then compare these results to those provided by phone surveys, and even slice them by market segment if they so wish.

Scenario 5: Four specific data points may be included in the dynamic data points XML configuration file. They are: processor speed (in megahertz), amount of RAM (in megabytes), capacity of the boot volume (in megabytes), and whether or not file sharing is activated. At the time specified in the task scheduler, the information-collection tool 200 is run. First, the server's information is written to the session file. In order to do this, the component asks the XML parser for both the user ID and the XML config file's version number. These two values are both assigned to their data points and written to the session file. Then the WMI querying component asks the XML parser for a list of every WMI query in the XML file. The requests for processor speed, RAM, and volume capacity are returned to the WMI querying component, which executes them. After the execution of each query, the component takes the result and turns it into a data point, based on the data type.

Once the data point has been created it is written to the session file. After this, the registry component asks the XML parser for a list of all the registry values which need to be read. In this example, only one registry location is returned, and it is the location of a flag (boolean) which specifies whether or not simple file sharing is turned on. The XML parser returns a struct to the registry component. The registry component reads the flag value at the registry location, and stores it to the specified data point which was also passed from the XML parser. Then the data point is written to the session file. At this point, all the data has been gathered. This is when transmission occurs. The session file may be sent to the SQM server using HTTPS or HTTP.

Particular implementation details of computer systems (e.g., server) that may execute aspects of the invention will now be described. These implementation details are provided by way of example only, and the invention is not limited to any particular implementation.

Methods described herein, acts thereof and various embodiments and variations of these methods and acts, individually or in combination, may be defined by computer-readable signals tangibly embodied on or more computer-readable media, for example, non-volatile recording media, integrated circuit memory elements, or a combination thereof. Computer readable media can be any available media that can be accessed by a computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, wireless media such as acoustic, RF, infrared and other wireless media, other types of communication media, and any suitable combination of the foregoing.

Computer-readable signals embodied on one or more computer-readable media may define instructions, for example, as part of one or more programs that, as a result of being executed by a computer, instruct the computer to perform one or more of the functions described herein, and/or various embodiments, variations and combinations thereof. Such instructions may be written in any of a plurality of programming languages, for example, Java, J#, Visual Basic, C, C#, or C++, Fortran, Pascal, Eiffel, Basic, COBOL, etc., or any of a variety of combinations thereof. The computer-readable media on which such instructions are embodied may reside on one or more of the components of any of systems described herein, may be distributed across one or more of such components, and may be in transition therebetween.

The computer-readable media may be transportable such that the instructions stored thereon can be loaded onto any suitable computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

Various embodiments according to the invention may be implemented on one or more computer systems. These computer systems, may be, for example, general-purpose computers such as those based on Intel PENTIUM-type processor, Motorola PowerPC, Sun UltraSPARC, Hewlett-Packard PA-RISC processors, or any other type of processor. Further, the embodiments may be located on a single computer or may be distributed among a plurality of computers attached by a communications network.

For example, various aspects of the invention may be implemented as specialized software executing in a general-purpose computer system. The computer system may include a processor connected to one or more memory devices, such as a disk drive, memory, or other device for storing data. Memory is typically used for storing programs and data during operation of the computer system. Components of the computer system may be coupled by an interconnection mechanism, which may include one or more busses (e.g., between components that are integrated within a same machine) and/or a network (e.g., between components that reside on separate discrete machines). The interconnection mechanism enables communications (e.g., data, instructions) to be exchanged between system components. The computer system also includes one or more input devices, for example, a keyboard, mouse, trackball, microphone, touch screen, and one or more output devices, for example, a printing device, display screen, speaker. In addition, the computer system may contain one or more interfaces that connect the computer system to a communication network (in addition or as an alternative to the interconnection mechanism.

The storage system typically includes a computer readable and writeable nonvolatile recording medium in which signals are stored that define a program to be executed by the processor or information stored on or in the medium to be processed by the program. The medium may, for example, be a disk or flash memory. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in the storage system, or in the memory system. The processor generally manipulates the data within the integrated circuit memory and then copies the data to the medium after processing is completed. A variety of mechanisms are known for managing data movement between the medium and the integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although the computer system discussed by way of example as one type of computer system upon which various aspects of the invention may be practiced, it should be appreciated that aspects of the invention are not limited to being implemented on the computer system. Various aspects of the invention may be practiced on one or more computers having a different architecture or components.

The computer system may be a general-purpose computer system that is programmable using a high-level computer programming language. The computer system may be also implemented using specially programmed, special purpose hardware. In the computer system, the processor is typically a commercially available processor such as the well-known Pentium class processor available from the Intel Corporation. Many other processors are available. Such a processor usually executes an operating system which may be, for example, the Windows® 95, Windows® 98, Windows NT®, Windows® 2000 (Windows® ME) or Windows® XP operating systems available from Microsoft Corporation, MAC OS System X available from Apple Computer, the Solaris Operating System available from Sun Microsystems, UNIX available from various sources or Linux available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

Network 219 may be any suitable type of network such a local area network (LAN), wide area network (WAN), intranet, Internet or any combination thereof. For illustrative purposes, a limited number of devices are shown in this example. However, it is to be appreciated that many devices may be coupled to network 219. Although the devices are illustrated as being coupled directly to the network 219, the devices may be coupled to the network through one or more servers, routers, proxies, gateways, network address translation devices or any suitable combination thereof.

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, J# (J-Sharp) or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or later developed, for performing the recited function.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method, implemented on a computer, of obtaining server usage information, comprising:
receiving first organization information related to a first organization that operates a first server;
receiving, over a network, first server information related to the first server;
receiving second organization information related to a second organization that operates a second server;
receiving, over a network, second server information related to the second server; and
determining server usage information based on the first and second organization information and the first and second server information.

2. The method of claim 1, wherein the first organization information comprises a number of employees employed by the first organization.

3. The method of claim 1, wherein the first organization information comprises a number of servers operated by the first organization.

4. The method of claim 1, wherein the server information related to the first server comprises information about hardware and/or software associated with the first server.

5. The method of claim 1, wherein the server information related to the first server comprises information about at least one role performed by the first server.

6. The method of claim 1, further comprising:
generating a report based on the server usage information.

7. The method of claim 1, wherein the first organization information comprises first market segment information and the second organization information comprises second market segment information.

8. The method of claim 7, wherein the first market segment information comprises a number of servers operated by the first organization.

9. The method of claim 7, wherein the first market segment information comprises a number of employees associated with the first organization.

10. The method of claim 7, further comprising:
generating a report based on the first and second server information and the first and second market segment information.

11. The method of claim 1, further comprising:
receiving organization information related to a plurality of organizations;
receiving, over a network, server information related to a plurality of servers operated by the plurality of organizations; and
determining server usage information based on the received organization information and server information.

12. A method, implemented on a computer, of providing server usage information, comprising:
receiving organization information related to a organization that operates a server;
receiving, over a network, server information related to the server; and
determining server usage information based on the server information; and
providing the server usage information to the organization that operates the server.

13. The method of claim 12, further comprising:
providing the server usage information to the organization over a network.

14. The method of claim 1, further comprising:
providing the server information to the first organization.

15. The method of claim 1, further comprising:
generating a report based on the server usage information.

16. The method of claim 15, further comprising:
providing the report to the first organization.

17. A computer-readable medium having computer-executable instructions implemented by a processor for performing steps comprising:
receiving first organization information related to a first organization that operates a first server;
receiving, over a network, first server information related to the first server;
receiving second organization information related to a second organization that operates a second server;
receiving, and over a network, second server information related to the second server; and
determining server usage information based on the first and second organization information and the first and second server information.

18. The computer-readable medium of claim 17, further comprising computer-executable instructions implemented by a processor for performing a step comprising:
generating a report based on the server usage information.

19. The computer-readable medium of claim 17, further comprising computer-executable instructions implemented by a processor for performing a step comprising:
generating a report based on the first server information.

20. The computer-readable medium of claim 19, further comprising computer-executable instructions implemented by a processor for performing a step comprising:
providing the report to the first organization over a network.
